(19) United States
(12) Patent Application Publication
(10) Pub. No.: US 2004/0249763 A1
(43) Pub. Date: Dec. 9, 2004

(54) License management for computing on demand

(75) Inventor: David Vardi, New York, NY (US)

Correspondence Address: OSTROLENK FABER GERB & SOFFEN, 1180 AVENUE OF THE AMERICAS, NEW YORK, NY, 100368403

(73) Assignee: Isogon Corporation

(21) Appl. No.: 10/859,302

(22) Filed: Jun. 1, 2004

Related U.S. Application Data
(60) Provisional application No. 60/476,260, filed on Jun. 4, 2003.

(51) Int. Cl. G06F 17/60

(52) U.S. Cl. 705/59

(57) ABSTRACT

A computer system with internally provided base-capacity and additional reserve capacity that is responsive to a capacity on demand signal to turn on and off additional computer capacity. A license manager interacts with the computer and receives from the computer system, capacity-related-metric information which dynamically varies over time and which causes the license manager to adjust licensing monitoring based on the capacity-related-metric information.

### CROSS-REFERENCE TO RELATED APPLICATIONS

The present invention is based on and claims priority to U.S. Provisional Application Ser. No. 60/476,260, filed on Jun. 4, 2003, entitled LICENSE MANAGEMENT FOR COMPUTING ON DEMAND.

### FIELD OF THE INVENTION

The present invention generally relates to computers and, more particularly, to enforcing software usage licensing terms.

### BACKGROUND OF THE INVENTION

Many computer-related hardware manufacturers provide computer systems having a variable hardware capacity. For example, IBM's zSeries 990 and Hewlett-Packard's iCOD can vary system features such as processor speed, total number of processors, processor performance and relative number of active processors. Typically, customers purchase computer systems having a base-capacity and subsequently purchase additional capacity as needed. Providers of variable hardware capacity computer systems receive customer demands and increase or decrease the capacities of the computer systems in terms of computing power and complexity accordingly. Typically, hardware is priced in relation to its capacity.

Computer systems having variable capacity have strained standard software licensing models. Licensors of commercial software operating on variable capacity computer systems attempt to structure licensing fees to reflect the capacity and use of the corresponding computer accurately. Often, capacity-related metrics determine the capacity of the computer system that operates the commercial software. A relatively simple software license includes a fee for operating the software on a computer system having a basic hardware capacity, plus additional fees for additional computing capacity beyond the basic hardware capacity. Thus, hardware vendors typically have billing systems that recognize enabled capacity of each customer's computer system for each day. This may be easily satisfied by hardware vendors that require customers to register the enablement of certain capacities. For example, IBM z990 customers are required to “order” extra hardware capacities and are charged accordingly. To disable some capacity, the customer must register a change with IBM, in effect informing the IBM billing systems of the lowered capacity. Additionally, IBM's “Call Home” facility sends hardware information back to IBM, providing it with another channel of information representing enabled hardware capacity.

Commercial software that is licensed using capacity-related metrics often includes or operates with validation systems that validate whether the software is running in environments which are compliant with current licensing terms and conditions. The commercial software may use a commercially available software application known in the art as a “license manager,” such as ISOGON'S IFOR or GLOBETROTTER'S FLEX-LM, that uses a “license key” to unlock at least one component of the commercial software. Some electronic form of the license, typically, is evaluated and a license key is provided for the validation system to audit and control the commercial software in accordance with the commercial software licensing terms and conditions.

Mainframe software license keys typically include a serial number and model type. Mainframe computers have a particular model number, thus the software vendor is assured that the software does not operate on a computer system having a different hardware capacity than that defined in the license. In order to upgrade computing capacity, such as to add an additional processor, the customer calls the vendor, pays an upgrade charge, and receives a new license key. With fixed-capacity computers, changes usually occur in the form of infrequent upgrades, so the impact on the vendor billing system is minimal.

When commercial software is licensed using capacity-related metrics in computer systems where the capacity of the machine is substantially fixed, validating that the commercial software is running in compliance with the licensing terms is relatively simple. Typically, when commercial software is initiated or executed, the validation system compares capacity-related metrics results with commercial software licensing terms and conditions, and reports the results to the license manager (or some internal process in the commercial software). The commercial software may react to the feedback of the validation system by ceasing to operate, operating in a different way, or ignoring the feedback. If a software vendor wants to enforce software licensing terms and conditions that are not met, the vendor can design its commercial software to stop operating, or require that one or more reports be provided to the software vendor. For example, the operator of commercial software may be required to transmit one or more reports that represents capacity-related metric information and may be generated by the validation system. Such reporting may also represent license fees that are owed to the software provider.

It is difficult to provide a mechanism to automatically enforce license provisions for variable capacity computer systems because the capacity-related metrics can change over time. Charging for the fixed capacity and ignoring the variable capacity seems unfair to the software vendor. A license with price terms that represent the highest possible capacity-related value seems unfair to a customer, who may be operating the computer system at the highest possible capacity only for a short duration such as one day a year. Alternatively, allowing the commercial software to operate on a computer system at the highest possible capacity without charging additional license fees forgoes potential revenue and is similarly unfair to the software vendor. Thus, a licensing and pricing mechanism that tracks capacity-related metrics and adjusts licensing terms and conditions dynamically is desirable. The known approaches to this object are described below.

As noted above, prior art commercial software licensing terms typically require a customer to contact the software supplier in advance when a change in computing capacity is needed. In response, the vendor may issue a license key that authorizes the commercial software to operate on the computer system with a different capacity. Such license keys can be for a specific or indefinite duration.

This approach to enforcing licenses is inconvenient because it requires customer-supplier communications each time capacity is increased or decreased. This hardware-licensing model creates a high-transaction volume and requires a significant investment in back-office operations, typically something only large vendors, such as IBM, can afford. Once this investment is made, the infrastructure that supports hardware billing can also support (with a relatively small, incremental investment) variable software pricing for software priced proportionally to the hardware capacity. However, such investment is beyond the ability of many, typically, smaller sized software vendors and, thus, an alternative method is needed.

Most IBM mainframe software vendors use a capacity-based pricing model which, for fixed-capacity computers, is simple to implement: The software vendor licenses the software to operate on specific hardware models that are known to have specific capacities. Billing reflects the licensing arrangement, and when the customer needs to grow and an upgrade is planned, the software vendor issues a new license key that allows for a new hardware model, usually at a higher cost.

Computer systems having a variable capacity such as the z990 create a dilemma for software vendors. For example, the amount that the software vendor should charge for such a system and which capacity to use for calculating license fees can be very difficult to ascertain. Although the fairest capacity-based model may represent only enabled capacity, similar to the way the hardware capacity is measured by a hardware vendor, a customer is required to convey variations in capacity to each software vendor. In turn, each software vendor is required to create an adjustable billing system and enhance back-office operations to receive customer input for all their licensed products. The investment required for this is burdensome on software vendors. If software vendors were ready to make such an investment, it is believed they would consider other licensing models that more closely reflect the use of their software, such as usage-based pricing, or IBM's Workload License Charges (WLC). Such licenses are not an option, partially, because of the prohibitive cost of retooling and maintaining the vendor back-office systems.

Software vendors providing software that runs on a computer system having a variable capacity face additional shortcomings. From an accounting point of view, software vendors need a guaranteed revenue stream from their software. While licensing fees relating to a fixed capacity of a computer system are guaranteed and can be realized immediately, fees associated with variable capacity are not, since future use is not assured. Thus, a portion of the software vendor's revenue stream is not immediately recognizable by the software vendor.

In an alternative prior art scenario, a report based on capacity-related metrics is provided to the software vendor on a regular basis, such as once a month. The software vendor audits the report based on capacity-related metrics to ensure that the customer operates within current commercial software licensing terms and conditions. Thereafter, the commercial software licensing terms (e.g., pricing) are adjusted to reflect changes in capacity, as represented by capacity-related metrics. Thus, information in the report is often incorporated into the software vendor's billing practices. In such an arrangement, the software supplier adjusts its commercial software pricing model to support the changes reflected by capacity-related metrics, which in many cases means the introduction of variability in software charges. Unfortunately, this may have negative implications for the commercial software supplier because accounting revenue recognition rules may not recognize potential revenue generating activity. Moreover, the volume of the reports may be very burdensome both to customers and commercial software suppliers. Customers may have to send periodic reports to dozens of vendors, and vendors may have to process periodic reports from thousands of customers. The result is overly cumbersome and costly at least in terms of time and money.

### SUMMARY OF THE INVENTION

The present invention recognizes a need for a practical solution that supports capacity-based licensed software needs to satisfy the following customer and vendor requirements:

customers are not charged for disabled capacity;

customers are not required to send information to vendors on a regular basis;

software vendors receive full payment for any enabled capacity;

software vendors can recognize received licensed revenue; and

software vendors do not need to drastically revamp back-office operations.

The present invention provides a system and method for implementing dynamic computer software licenses for customers operating variable capacity computer systems. Further, the present invention accommodates urgent and unexpected needs to change computer system capacity.

A need exists for commercial software suppliers to provide commercial software in which the license includes pricing terms that support capacity-related metrics without the need for capacity-related metrics reporting, and without the need to change the software pricing model to a variable pricing model.

The present invention facilitates software pricing that correlates to varying capacities of computers, and thus addresses customers concerns about the relationship between software pricing and the capacity-related metrics.

The present invention further removes the need for modifying the commercial software supplier billing system to adjust to feedback reports form the customer.

The present invention further provides a method for licensing software in ways where the revenue can be fully recognized (because the capacity duration metrics does not have to be refundable).

The present invention further removes the need for frequent reporting from the customer to the supplier.

Other features and advantages of the present invention will become apparent from the following description of the invention which refers to the accompanying drawings.

### BRIEF DESCRIPTION OF THE DRAWINGS

FIG. 1 is an overall block diagram of a license manager that is adapted to respond to capacity related metrics for commercial software on a dynamic basis.

FIG. 2 is a block diagram illustrating a computer hardware arrangement with dynamically changeable CPU hardware capacities.

FIG. 3 is a block diagram illustrating several aggregated computer systems in accordance with an example embodiment of the present invention.

### DETAILED DESCRIPTION OF PREFERRED EMBODIMENTS OF THE INVENTION

The present invention enables commercial software suppliers to provide commercial software with licensing terms that substantially automatically enforced using capacity-related metrics, without the need for capacity-related metrics reporting and without the need to change the software pricing model to a variable pricing model after a review of capacity-related reports.

The present invention comprises several elements for enforcing licensing terms for commercial software that operates in a variable hardware capacity computing environment. In an example embodiment, one or more metrics are employed that factor in a duration measurement, and are further combined with capacity-related metrics. The combination, referred to herein, generally, as “capacity duration metrics,” is used to enforce commercial software licensing terms that accurately represent capacity-related metrics on a variable capacity computer system, and measured over time.

Preferably, commercial software licensing terms are enforced using capacity duration metrics that represent the capacity of the computer system over a period of time and referred to herein, generally, as a “capacity duration.” In an example embodiment of the present invention, a customer licenses commercial software according to a capacity duration. The licensing terms are enforced by a validation system which tracks the capacity-related metrics and deducts from (i.e., “consumes”) the capacity duration as determined by capacity duration metrics, preferably for a duration specified in the capacity duration metrics. As the capacity-related metrics indicate changes in computer capacity usage over time, the rate by which the capacity duration value is consumed likewise changes. When a specific amount or percentage of the originally licensed capacity duration metrics is reached, a warning may be provided by the validation systems or the commercial software to the customer, alerting the customer that a new license key replenishing the capacity duration metrics is required and/or provided. When the value provided by the capacity duration metrics totally consumes the capacity duration, the validation system may indicate that the commercial software licensing terms and conditions are violated and/or an example embodiment of the present invention, the validation system enforces terms of the license by supplying (or withholding) one or more license keys.

As used herein, the term, “module” refers, generally, to one or more discrete components that contribute to the effectiveness of the present invention. Modules can operate with or, alternatively, depend upon, one or more other modules in order to function.

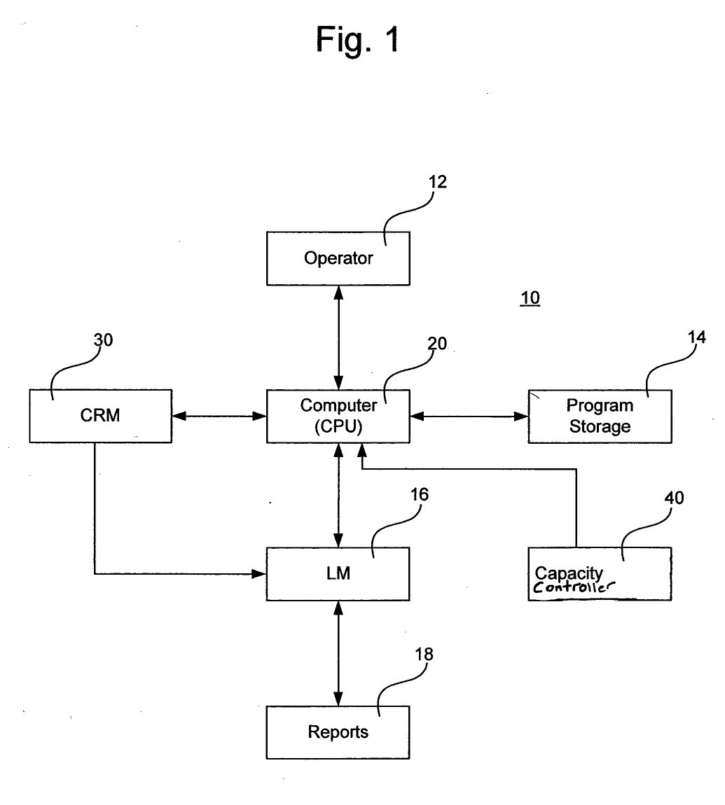

Referring to the drawing figures, in which like reference numerals represent like elements, there is shown in FIG. 1 a typical data center or computer environment 10 which includes a central computer 20 with CPU power that includes a base capacity and additional capacity that can be turned on and off to realize a “capacity on demand” functionality. In known manner, the computer 20 which can consist of a single computer or plural computers, interacts with program storage 14 which contains various software applications or even an operating system for the computer 20. The computer 20 is controllable by an operator 12 who can issue commands that result directly or indirectly via interaction with a remote controller of a computer program licensor to alter the dynamic capacity of the computer through instructions issued by a capacity controller 40, as shown. Information regarding the instantaneous computer capacity of the computer 20 is communicated via the capacity-related metrics facility 30 to a license manager 16 which controls access to licensed software that is resident in the program storage 14 and usable based on licensing terms in well known manner. The license manager may output reports 18 which can be either hard copy or electronic and may be communicated locally or to one or several software licensing entities.

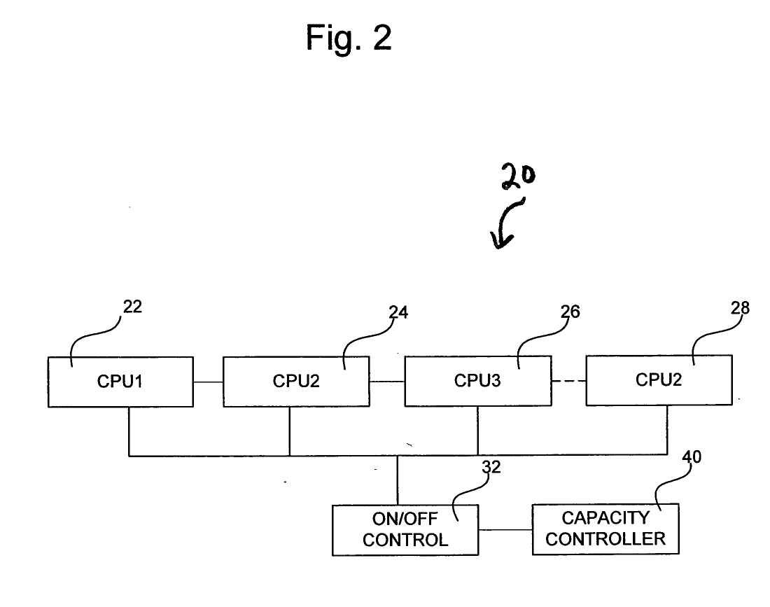

Turning to FIG. 2, the computer 20 is illustrated as a series of CPUs 22, 24, 26 and 28 which are responsive to on/off controls from a controller 32 to turn CPUs on and, off based on required capacity demands that is placed on a system by running software. The on/off control 32 is responsive to the capacity controller 40.

To illustrate by way of example, a customer has a traditional fixed-capacity computer rated at 1,000 MIPS (the number of instructions, in millions, that a computer can execute in a second) and a software product licensed for a year, beginning on January 1. The product capacity duration is therefore 365,000 MIPS-days. Every day of the year, a capacity duration of 1,000 MIPS-days is deducted from the product's capacity duration. Thus, at the end of the year, the customer replenishes the product's capacity duration for operators during the next year.

Continuing with the present example, on July 1, the customer decides to upgrade to a larger fixed-capacity computer rated at 2,000 MIPS. From a capacity duration point of view, the capacity duration is now consumed twice as fast as before. In the prior art, the customer would need to contact the vendor by the end of September to replenish the product capacity duration, and the software vendor would get the opportunity to charge for this. In accordance with an example embodiment of the present invention, a license key is provided substantially automatically as the customer does not need to contact the vendor. The benefit for customers is that they are able to upgrade without the urgent need to obtain a new license key. The commercial software vendor can price the software based on the highest MIPS available to the server in each day, in other words, the daily MIPS high-water mark. Accordingly, the capacity duration metrics factor in units of “MIPS days.”

In another example, a particular customer has a variable capacity computer system having a base capacity of 1,000 MIPS, and further provided with two “engines,” each engine having a capacity of 200 MIPS. Initially each of the two engines are configured not to operate, and each engine can be turned on independently. Thus, on any given day the variable capacity computer system might operate at 1,000 MIPS, 1,200 MIPS, or 1,400 MIPS. The capacity duration metrics determines the rate of operation, which is preferably used to adjust license fees. The customer estimates that over the next year he will be using the base capacity alone for 175 days, base capacity plus one additional engine for 130 days, and base capacity plus both additional engines concurrently for another 60 days. The customer therefore purchases from the commercial software supplier a capacity duration metrics license key for 415,000 MIPS Days (1,000 MIPS times 175 days plus 1,200 MIPS times 130 days plus 1,400 MIPS times 60 days). If, during the year, the customer uses the extra capacity on more days than anticipated, he will consume his capacity duration much faster, and need to replenish his capacity-related credit before the end of the year. If he uses extra capacity on fewer days than he originally estimated, he will end the year with a surplus, which may be applied to the following year's purchased license key, used to defer the need to obtain a new license key, or he may receive a refund.

A validation system that is capable of tracking capacity-related metrics may dynamically perform such tracking by monitoring the environment of a variable capacity computer system, or by periodically reading and interpreting reports and logs from other systems that track or report on capacity-related metrics changes. As indicated earlier, such functionality of the validation systems may be embedded in the commercial software application.

In another example embodiment of the present invention, the commercial software supplier may structure license fees based on MIPS, as described above, but in a non-linear fashion. For example, instead of the capacity duration metrics being “MIPS days” as described and calculated above, it might be “square root of MIPS days”, whereby a daily deduction amount provided by the capacity duration metrics from the customer's pre-paid duration capacity would be equal to the square root of the current day's capacity-related metrics. If, as in the previous example, the customer has a 1,000-MIPS base system and estimates that over the next year, he will be using one additional engine on 130 different days, and both additional engines concurrently on another 60 days, he would purchase a capacity duration metrics license key for 39,000 units of “square root of MIPS days”: 100 (square-root of 1,000) times 175 days plus 110 (approximate square root of 1,200) times 130 days plus 120 (approximate square root of 1,400) times 60 days. (Note that square root of MIPS days would of course be priced quite differently than MIPS days.) Such a licensing metric, as compared with the linear metric in the previous example, can be used by commercial software suppliers to grant discounts in certain circumstances, as compared to certain other circumstances. Thus, licensing terms that are based on square root of MIPS day progressively lower as the variable MIPS rating gets higher, similar to a quantity discount.

In another embodiment, the commercial software supplier licenses the commercial software according to ranges of capacity-related metrics. Referred to herein, generally, as “bands” of capacity duration metrics, the validation system consumes the value provided by licensed capacity duration metrics in increments that represent the bands according to the capacity-related metrics it tracks. For example, a commercial software might be licensed using multiple bands, based on the number of active MIPS of capacity on a given day: from 10 to 500 MIPS consumes 150 units from those licensed; from 510 to 1,100 MIPS consumes an additional 120 units; from 1,110 to 1,700 MIPS consumes an additional 100 units; from 1,710 to 2,300 MIPS consumes an additional 80 units; etc. Under this metric, the same customer described above would purchase a capacity duration metrics license key for 117,550 units of “Band Days”: 270 times 175 days (on which bands one and two would apply) plus 370 times 190 days (on which bands one, two and three would apply). Note that “Band Days” could be structured as either a linear or non-linear pricing metric.

In another example embodiment, the capacity duration metrics is based not only on capacity-related metrics, but also on how much processing the product consumes (or is allowed to consume) using a “MIPS Minutes of Processing” metric. For example, a product that executes for 24 hours, using 1% of a 3,000 MIPS CPU, would have used 43,200 units of such a capacity duration metrics (1% of 3,000 MIPS times 24 hours times 60 minutes). As another example, a product which is executed as 29 batch jobs each day, each running for 2 minute, and using 50% of the 3,000 MIPS CPU each time it's executed (or, as is exactly equivalent, if the CPU is heavily loaded, runs for 4 minutes using 25% of the total 3,000 MIPS), would use 87,000 units (50% times 3,000 MIPS times 29 jobs times 2 minutes). Note that this metric has the advantage that if processing need stays constant, the consumption of the capacity duration metrics units will also stay constant, even if the capacity-related metrics changes, because all product-executions will require less execution-time to complete their processing. For example, if the CPU had additional capacity turned on to upgrade from 3,000 MIPS to 5,000 MIPS, the number of units of “MIPS Minutes of Processing” consumed by the two above products would not change. The first product would only require 0.6% of the CPU, not 1%, and would therefore still use 43,200 units (0.6% of 5,000 MIPS times 24 hours times 60 minutes). And the second product would run for 1.2 minutes each time it's executed, not 2 minutes, and would still use 87,000 units (50% of 5,000 MIPS times 29 jobs times 1.2 minutes).

In another example embodiment the commercial software supplier provides commercial software with licensing terms and conditions that include some allowances or “grace factors” whereby the commercial software can be used with a capacity-related metrics that exceeds some licensed capacity duration metrics for a limited duration, a limited number of times, or a combination thereof, before consuming the capacity duration metrics in full or partial units of capacity duration metrics.

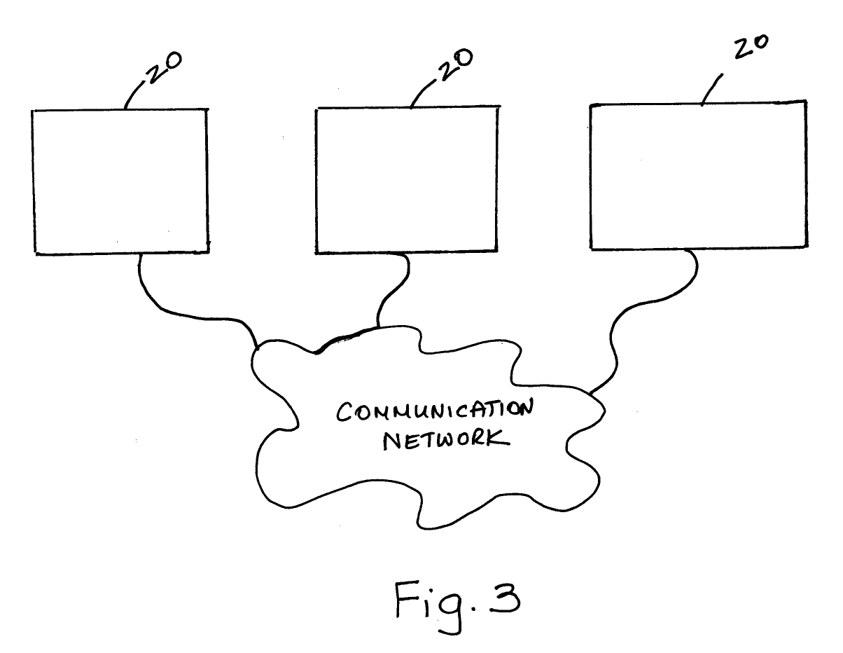

In another embodiment, a commercial software supplier provides commercial software with licensing terms and conditions that provide some allowances for aggregating the capacity-related metrics on several aggregated computer systems. FIG. 3 illustrates an example embodiment of the present invention wherein a plurality of computers 20 are provided, some or all of which are variable capacity computer systems. In the example environment shown in FIG. 3, the capacity duration metrics is consumed by the several aggregated computer systems based on a consumption algorithm dependent on the commercial software licensing terms and conditions. In such an arrangement the capacity duration metrics consumption may vary based upon the varying capacities of each computer in the several aggregated computer systems, as well as by joining or disjoining or computers in the several aggregated computer systems, whether each computer in the several aggregated computer systems is a variable capacity computer systems or not.

In another embodiment the validation systems provides customers with information that projects, based upon calculated capacity duration metrics consumption, the date whereby the capacity duration metrics would need to be renewed. For example, each day the license manager (or equivalent process) recognizes the duration capacity balance, and, based on the current MIPS, estimates the date when the estimated duration capacity will be consumed. The date is then conveniently provided to the customer.

In another embodiment the system provides feedback to the variable capacity computer systems so that it could constrain the amount of capacity it provides the commercial software to ensure that the commercial software would not consume the capacity duration metrics at a rate beyond one acceptable to the user. The feedback could be specified in terms of maximum capacity duration metrics to be consumed per a given duration, minimal capacity duration metrics amount that must be available per duration, minimal capacity duration metrics that must be available by specific dates, or combination of these.

In another embodiment the commercial software supplier may elect to license several commercial software products in a combined manner (“commercial software POOL”) for variable capacity computer systems whereby any commercial software in the pool consumes the same or different amounts of capacity duration metrics in the variable capacity computer systems.

The customer can purchase from the software vendor as much product capacity duration as they like, according to their capacity estimates. A customer who predicts using 1,000 base-capacity MIPS, with an additional on-demand 500 MIPS 10 days a year, would need a capacity duration of 370,000 MIPS-days (1,000 MIPS for 355 days and 1,500 MIPS for 10 days). If the customer uses the extra capacity for more than 10 days, he will have to replenish it before the end of the year.

The benefits of the present invention are more pronounced with the On-Off capacity on demand computers: The customer has the freedom to change the capacity of his capacity on demand computer at will, without having to contact the vendor for a license key or report to the vendor on the use of the site's computers.

Capacity duration metrics can use different durations and different capacity factors. The previous examples used MIPS-days. Other environments could use Engine-days, MIPS-months, etc. A preferred metric depends on specific capacity on demand functionality and licensing models.

Capacity duration systems are flexible enough to offer interesting variations. For example, additional capacity duration metrics could be consumed on a cluster of computers (e.g., IBM's PARALLEL SYSPLEX technology) and allow licensing for the cluster. In this case, the capacity duration is consumed by every member of the cluster, allowing software vendors to license products to the capacity duration of the entire cluster.

Software vendors can choose whether to use a unique capacity duration metric for each product or to share a capacity duration metric for several products. This may offer vendors the ability to package products together under a single price.

Capacity duration metrics can be utilized with perpetual and rental license models. In a perpetual license model, the customer purchases a perpetual license to run software on specified machines with an agreed-upon capacity. As part of the agreement, the software vendor commits to providing the customer the agreed-upon product capacity duration on a regular basis (for example, once a year). This arrangement, compared to traditional fixed-capacity licensing, requires the added annual interaction between vendor and customer, but it gives the customer the benefit of supporting capacity on demand computers at an equitable pricing model. In such an arrangement, the license is perpetual and the annually replenished capacity duration license key is merely an administrative matter. Because the license is perpetual, and the license fees are non-returnable, the license fees can be fully recognized by the software vendor (in accordance with software revenue recognition rules as presented in the American Institute of Certified Public Accountants' [AICPA's] Statement of Position No. 97-2 and Statement of Position No. 98-9, as well as general revenue recognition rules presented in the Securities and Exchange Commission [SEC] Staff Accounting Bulletin No. 101]. There may be separate rules regarding support, maintenance, and services. Software vendors typically price their software for profitability, so a better model for software vendors translates into better prices for customers.

The rental model is actually very similar to the perpetual model. The main difference is that in the rental model, the vendor is not required to replenish the capacity duration after it is fully depleted. In a typical arrangement, the customer would license the product for a specific amount of capacity duration. If the customer uses additional unplanned on-demand capacity, that amount would need to be replenished earlier than previously anticipated. From the vendor point of view, similar to other rental models, revenue is recognized over the term of the rental (as defined by the duration element of the capacity duration for the computer). If the product capacity duration is depleted earlier than the expected rental term, the remainder of the revenue can be recognized at once by the vendor. A renewal rental term would start a new transaction.

For the convenience of having to use a license key that needs to be replenished once a year, customers gain several benefits. The main functional benefit is the ability to pay for utilized capacity only. Additionally, the reporting needs of the vendors are significantly reduced, as there is no need to send software vendors usage information on an ongoing basis. The same benefits also exist when customers upgrade into a new machine that supports the capacity duration model.

Capacity duration metrics provide software vendors a mechanism to support capacity on demand computing without requiring a major overhaul of their internal management system. It provides the ability to be fair to customers without losing potential revenue. From a practical point of view, customers using additional capacity would simply replenish their capacity duration allowance sooner. The number of these interactions would be only slightly higher for customers with on-demand computing than those without it. Additionally, there is full accounting recognition for sold product capacity durations.

There is one additional customer benefit of a capacity duration system. A side effect for capacity duration licensing is the break in the direct link between the hardware upgrades and software upgrade charges. This link is a major issue in the IBM mainframe environment. Some industry experts maintain that the immediate software costs associated with hardware upgrades have a discouraging effect on customers considering hardware upgrades. Some even consider this link to be a major growth inhibitor for the mainframe platform.

With capacity duration metrics, the customer can upgrade hardware (either to a capacity on demand computer or a larger fixed-capacity computer) and not have to pay upgrade charges until the capacity duration is depleted. A time gap is generated between the hardware upgrade and the renewal of software licenses. Eventually, charges go up, but they may well occur in a different budget year and under different circumstances. Additionally, since replenishment would occur at different dates for every product, the effects of the upgrade would be less drastic.

The time gap also puts customers in a better position to negotiate renewed licensing terms. When upgrades occur because of unanticipated needs for additional capacity, the customer rushes to renegotiate upgrades with software vendors. The customer's negotiating position is weakened; vendors know that since a new upgrade date is looming, the customer must conclude negotiations if they want to use the software on the upgraded hardware. In capacity on demand environments with capacity duration licensing, the customer can use the additional capacity and negotiate replenishment of product capacity durations from different vendors with significantly reduced deadline pressure.

Capacity duration metrics provide a flexible solution for licensing software on capacity on demand computers. Assuming a basic operating system and licensing system infrastructure, the system is relatively easy to implement and provides new licensing options that address customer and software vendor needs alike.

Benefits of the present invention are now provided by way of another example. ACME Corp. purchases a new IBM z990 Model 2084-A08. The machine is equipped with eight engines, but ACME needs only five for normal day-to-day operations. Should an increase in business needs arise, ACME can turn on up to three additional engines.

ACME decides to license software from an independent software vendor that supports the capacity duration model. ACME makes a conscious decision not to pay in advance for the capacity of the inactive engines, so it licenses the product for 724,525 MIPS-days (365 days of 1,985 MIPS per day, accounting for the Gartner MIPS rating of five engines). ACME receives a license key that provides for these 724,525 MIPS-days.

At the end of June, ACME realizes that business is picking up, and that ACME will indeed need to process a growing number of transactions. To accommodate some regulatory deadline, ACME needs to complete the task by August 1. The capacity managers propose to activate two of the three additional engines on the machine for the month of July. ACME software asset managers calculate that with the additional capacity, their original licensed 724,525 MIPS-days would expire on December 20 rather than on December 31. On July 1, two additional engines are turned on, and on July 31 they are turned off. The machine runs with seven engines for 31 days. Each of these days the machine provides 2,669 MIPS, consuming an additional 684 MIPS-days per day (see FIG. 1).

In accordance with the present invention, ACME does not need any special license key from the ISV to turn the engines on or off. It does not even need to communicate that fact to the ISV. The only impact of the change is that ACME has to replenish the capacity duration from the vendor by December 20. ACME asset managers had plenty of time to negotiate that upgrade, and act without time pressure.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A licensed software management system, the system comprising:
a module that defines a granted right to utilize licensed software based on a capacity of a computer system;
a metrics module that repeatedly measures the capacity of the computer system to provide measured capacity values of the computer; and
a license manager that utilizes the granted right based on the measured capacity of the computer system.

2. The system of claim 1, wherein the capacity is a function of at least one of computing performance, output provided by the computer system, computing performance over time, and a number of users concurrently using the software.

3. The system of claim 1, wherein the capacity is a function of any combination of computing performance, output provided by the computer system, computing performance over time and number of users concurrently using the software.

4. The system of claim 1, wherein the license manager recognizes when the capacity of the computer varies.

5. The system of claim 1, further comprising a software lock module that prevents the software from operating on the computer system.

6. The system of claim 5, further comprising a license key that comprises at least one of the model of the computer system and the serial number of the computer system, wherein the license key certifies the software to operate on the computer system.

7. The system of claim 6, wherein the license manager module substantially automatically provides the license key to the software lock module to enable continued operation of the software on the computer system.

8. The system of claim 1, wherein the license manager module is distributed with the software or separate from the software.

9. The system of claim 1, wherein the license manager is adapted to utilize the grated rights by at least one of enabling continued operation of the software, providing a warning, communicating with a provider of the software, and preventing operation of the software.

10. The system of claim 1, wherein the computer system has at least one of a fixed capacity and a variable capacity.

11. The system of claim 1, further comprising a payment module that is adapted to receive payment from a customer.

12. The system of claim 11, wherein the payment module is further adapted to receive payment from a customer when the license manager determines that capacity of the computer system has varied.

13. The system of claim 1, wherein the license manager utilizes the granted rights in a non-linear fashion.

14. The system of claim 13, wherein the non-linear fashion represents a square root of the capacity value in terms of millions of instructions processed per second.

15. The system of claim 13, wherein the non-linear fashion represents bands of capacity duration metrics.

16. The system of claim 13, wherein the non-linear fashion represents capacity in terms of millions of instructions processed per second for at least one minute.

17. The system of claim 15, wherein the non-linear fashion includes a grace period free of charge.

18. The system of claim 1, wherein the license manager monitors capacity information regularly over time.

19. The system of claim 1, wherein the capacity information represents a capacity of a plurality of aggregated computer systems.

20. A method for utilizing a granted right to licensed software, the method comprising:
defining a granted right to utilize licensed software based on a capacity of a computer system;
repeatedly measuring the capacity of the computer system to provide measured capacity values of the computer; and
utilizing the granted right based on the measured capacity of the computer system.
